(19) United States
(12) Patent Application Publication
(10) Pub. No.: US 2019/0236035 A1
(43) Pub. Date: Aug. 1, 2019

(54) STANDARDIZED DEVICE DRIVER HAVING A COMMON INTERFACE

(71) Applicant: Microsoft Technology Licensing, LLC, Redmond, WA (US)

(72) Inventors: Sathyanarayanan KARIVARADASWAMY, Sammamish, WA (US); Naveen THUMPUDI, Redmond, WA (US)

(21) Appl. No.: 15/886,798

(22) Filed: Feb. 1, 2018

(51) Int. Cl. G06F 13/10; G06F 9/4401

(52) U.S. Cl. CPC G06F 13/102; G06F 9/4411

(57) ABSTRACT

A system for camera device command and control detects a camera device connected to the system and accesses a set of interfaces defined by a standardized driver. The set of interfaces are a common set of interfaces associated with a device object and the device object is compatible with camera devices from different camera device manufacturers. The system queries the detected camera device for descriptors defining capabilities of the camera device using a packetized command generated based at least on the accessed set of interfaces and provides, based on the descriptors, one or more interfaces of the accessed set of interfaces to one or more applications to make the camera device available to the one or more applications, thereby simplifying connection of camera devices from different manufacturers and improving the user experience. The system then allows the camera device to be controlled.

### CROSS-REFERENCE TO RELATED APPLICATION

This application is related to co-filed U.S. application Ser. No. 15/886,785, entitled “DISCOVERY OF NETWORK CAMERA DEVICES”, having Docket No. 403609-US-NP and filed Feb. 1, 2018, which is incorporated by reference herein in its entirety.

### BACKGROUND

Various manufacturers provide devices, such as cameras, for connection to computing systems. These devices can have different configurations and different kinds of communication busses (e.g., read/write busses) that use special commands to connect to and communicate with the devices. Each of the different devices make use of compiled drivers that are configured for use with the particular device type. For example, digital cameras have a variety of different manufacturers that provide cameras with different control interfaces, as well as different bus configurations/types, such as Universal Serial Bus (USB), Peripheral Component Interconnect (PCI) and Mobile Industry Processor Interface (MIPI), among others. In order to communicate with a particular digital camera, a specific driver adapted with special commands and communication protocols for communication with the particular camera type are needed.

Presently, for a system to communicate with different types of cameras having different manufactures, different hardware configurations or different command control requirements, a different driver is loaded to allow for communication with each of the cameras. This process adds complexity to the control arrangement for communicating with the cameras, as well as adding time for the multiple installations and time to separately update each of the drivers.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

A computerized method for camera device command and control comprises detecting a camera device connected to the system and accessing a set of interfaces defined by a standardized driver, wherein the set of interfaces are a common set of interfaces associated with a device object. The computerized method further comprises querying the detected camera device for descriptors defining capabilities of the camera device using a packetized command generated based at least on the accessed set of interfaces and providing, based on the descriptors, one or more interfaces of the accessed set of interfaces to one or more applications to make the camera device available to the one or more applications. The computerized method additionally comprises receiving a command from the one or more applications via the provided one or more interfaces and controlling the camera device based on the received command.

Many of the attendant features will be more readily appreciated as the same becomes better understood by reference to the following detailed description considered in connection with the accompanying drawings.

### BRIEF DESCRIPTION OF THE DRAWINGS

The present description will be better understood from the following detailed description read in light of the accompanying drawings, wherein:

FIG. 1 is an exemplary block diagram illustrating a camera according to an embodiment;

FIG. 2 illustrates an exemplary driver arrangement according to an embodiment;

FIG. 3 illustrates an exemplary control arrangement according to an embodiment;

FIG. 4 illustrates an exemplary control data packet according to an embodiment;

FIG. 5 is an exemplary flow chart illustrating a method for camera device command and control according to an embodiment;

FIG. 6 is an exemplary flow chart of a driver installation method according to an embodiment; and

FIG. 7 illustrates a computing apparatus according to an embodiment as a functional block diagram.

Corresponding reference characters indicate corresponding parts throughout the drawings. In the figures, the systems are illustrated as schematic drawings. The drawings may not be to scale.

### DETAILED DESCRIPTION

The computing devices and methods described below are configured to efficiently communicate with cameras having different hardware configurations and communication interfaces, such as camera devices provided by different manufacturers. A single driver, referred to as a bus agnostic or universal driver, allows for communication with all of these camera devices. In one example, a set of interfaces supported by low level firmware, along with a driver, implements a command and control interface and a buffer interface that is camera type agnostic. This allows for more efficient and simplified communication with the camera devices, and improves the user experience.

Using a standardized driver of the present disclosure, a set of interfaces that is compatible with camera devices from different manufacturers is provided by a common device object for all of the different camera types. With a packetized command formatted according to the single standardized driver, connection and communication with different camera devices is simplified, including reducing the time and resources used for installing the camera devices, as well as updating the capabilities of the camera devices.

Although the examples described and illustrated herein are implemented with a camera device having particular features and having a particular bus configuration, these are only exemplary implementations and not a limitation. As those skilled in the art will appreciate, the present disclosure is suitable for application in a variety of different types of camera devices having any type of bus configuration, as well as non-camera devices, such as other peripheral devices capable of being connected to a computing device.

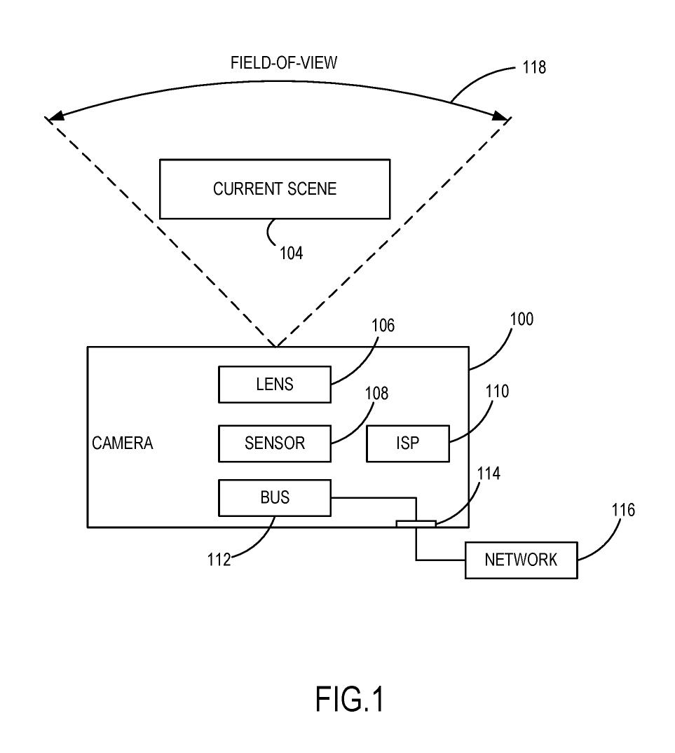

FIG. 1 is an exemplary block diagram illustrating a camera device, specifically, a camera 100 capable of capturing images (e.g., still images or video) and that may be configured to communicate using a standardized driver. The camera 100 (e.g., a USB digital camera) can acquire a plurality of images of a scene 104 (illustrated as a current scene) using a lens 106 and a sensor 108 (e.g., a charge-coupled device (CCD) or a complementary metal-oxide-semiconductor (CMOS) active pixel sensor) of the camera 100. The camera 100 further includes an image signal processor (ISP) 110 configured to process the data from the sensor 108 to generate images, such as streaming video. The ISP 110 in some examples is a specialized digital signal processor (DSP) configured for image processing in the camera 100. The components of the camera 100, including the ISP 110 are configured to be controlled using different device commands that are abstracted as described in more detail herein.

The camera 100 also includes a bus 112 having a particular configuration, such as, but not limited to, USB, PCI or MIPI. The bus 112 allows communication of data within the camera 100 and external to the camera 100 via a connector 114. For example, the connector 114 allows for connection of the camera 100 to a network 116 to transfer data to the network 116, such as still images or video (e.g., USB camera video images) captured within a field-of-view 118 of the camera 100.

It should be noted that the “standardized commands” of various examples flow in either direction between the host and the camera device (e.g., the camera 100). As used herein in various examples, a “standardized command” includes instructions, data, and interrupts. When a “standardized command” flows from the host to the camera device, in some examples, this includes instructions such as mode changes, along with any associated data. Similarly, when a “standardized command” flows from the camera device to the host, in some examples the command includes one or more of interrupts, device descriptors, pixel data in some form, etc.

It should be appreciated that the camera 100 in various examples is configured having different functionalities. In one example, the camera 100 is configured to perform at least one of computer vision, including, presence detection, motion detection, object categorization, imminent collision detection, etc.

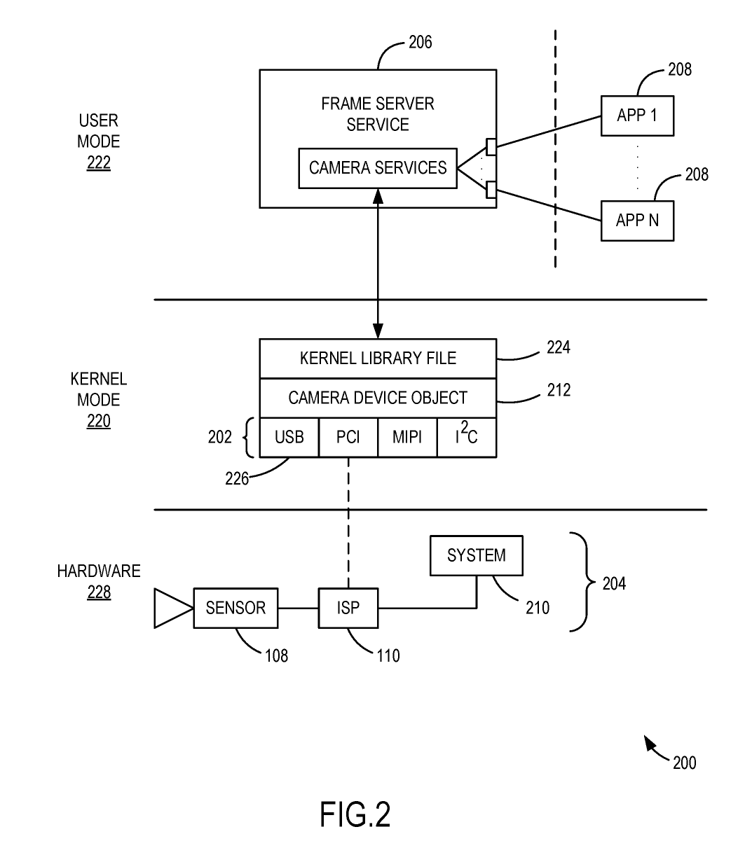

FIG. 2 illustrates a system 200 for implementing a single driver configuration to communicate with camera devices (also referred to as cameras) having different communication buses. In one example, a new set of interfaces supported by low level firmware, along with a driver 202, implements a command and control interface and a buffer interface. For example, the system 200 allows for communication with a sensor 108 within a device 204, such as a USB camera device, a PCI camera device, a MIPI camera device, etc. from different manufacturers (communicating with a system 210 of the device 204) with standardized packetized commands understood by the device 204. The packetized commands allow for communication with the ISP 110 within camera devices having different control command requirements and bus configurations. As a result, a plug and play interface is provided for communication with different camera devices that are compliant with the packetized command standard. It should be noted that the packetized commands in various examples define standardized controls that include instructions and/or data.

For example, when the device 204 includes the sensor 108 configured as a USB sensor, connected to the system 200 for the first time, the driver 202 gets loaded and descriptors (e.g., resolution, frame rate, media types, etc.) of the sensor 108 are queried in a kernel mode 220 (illustrated as a kernel mode environment). The kernel mode 220 in various examples is a privileged execution mode (or protected mode of operation) in which processes perform functions, such as interacting with hardware (illustrated as the device 204) that processes executing in user mode are prohibited from performing. The descriptor contains information about the device 204. In one example, a single device descriptor is provided for the device 204 that contains relevant information about the device 204. The descriptors are used by the operating system to derive different sets of information using processes in the device descriptor generation technology.

The descriptors are then exposed to the operating system, for example, to define camera services 214 of a frame server service 206 in a user mode 222 (illustrated as a user mode environment), such that a plurality of applications 208 are enumerated and “see” the device 204, as well as other devices 204 that are compliant with the driver 202 (e.g., all the available USB cameras compliant with the standardized driver). Thereafter, an application programming interface (API) call can be made, for example, to start streaming from the device 204, such as a specific USB camera.

For example, a camera device object 212 is created for each compliant device 204, which can then be selected by a user in the applications 208 (e.g., in a camera select drop down menu). With the plug and play functionality for any camera sensor 108 compliant with the standard defined for the driver 202, the system 200 is capable of recognizing and communicating with devices 204 (e.g., cameras) having different configurations from different manufacturers, as well as different communication bus configurations. That is, the frame server service 206 of the operating system is enabled to access images, such as video frames, from cameras having different control command requirements and communication buses using a single driver 202 defined by the camera services 214 identified for each of the cameras. The driver 202 in one example defines a kernel mode interface to the camera device object 212 that allow communication with the device 204 regardless of the type of camera implemented by the device 204. This plug and play functionality using the single driver 202 results in increased operating system stability, decreased partner investment, an entire ecosystem that is less likely to experience crashes, and only one driver being needed for an update.

It should be noted that the camera device object 212 is a common device object that can work with different camera types, rather than requiring separate drivers for each device 204 having a different type (e.g., different manufacturer type). The present disclosure also provides a standard way of interfacing with any device, particularly any type of camera connected to the system 200, without using a specialized procedure for different cameras.

The system 200 is also configured with a discoverability function to identify which command is available in a particular hardware via a particular bus. That is, the functionality for commands differs for each of the different camera types, and various examples allow for discoverability of all of these different commands.

More particularly, the driver 202 implements a command and control interface, and buffer interface, defining a set of interfaces supported by low level firmware. In one example, a common set of interfaces (defining a “standard” that the device 204 implements) allows data captured from the sensor 108 communicated over different camera types to be available to the operating system. The command and control structures in various examples manage the camera control scheme, data payload and buffer structure. The commands can include any command type, such as, but not limited to start streaming, stop streaming, querying all capabilities (hundreds of characteristics), querying camera frame data (which can be raw data, compressed data, or uncompressed data), querying partial frames and assembling the partial frames, configuring of the streams, focus (auto and manual), etc. As should be appreciated, packetization is bus-specific and the device format running on a device 204 is compliant with the standardized driver described herein to enable the command and control structures.

In one example, the driver 202 (running in the kernel mode 220) abstracts the differences between the command and control structures for communicating with the different camera types to provide a common set of interfaces for the operating system to allow communication with the device 204 in the user mode 222 (e.g., streaming video via one of the applications 208 or other functions of the operating system or other program modules). For example, the driver 202 abstracts the command and control scheme for the different camera types to define how to acquire camera frame data and how to assemble partial frames in the operating system. In this way, a bus agnostic camera class driver allows cameras operating using different command control requirements (and different buses) to be exposed to the operating system without the use of different drivers for each of the different cameras. With the abstraction having the common device object, namely the camera device object 212, standardized packetized commands are provided that are understood by the device 204 regardless of the camera configuration or control scheme implemented by the device 204. For example, the command and control structures and data payload configured according to the present disclosure is sent to the ISP 110 of the device 204 to configure the device 204, thereby allowing communication with the device 204, such as to stream video from the device 204.

It should be noted that in the kernel mode 220, additional components or objects are provided in some examples, including a kernel library file 224. The kernel library file 224 is a shared library or shared object that can be shared by different executable files. In one example, the kernel library file 224 is a dynamic-link library that is a code library that can be used by multiple processes, while only one copy is loaded into memory. As should be appreciated, the kernel library file 224 implements different functions in the kernel mode 220 that allows for processes to communicate with hardware in this protected mode. In one example, the kernel library file 224 is a common kernel-mode library that allows the one or more of the applications 208 to access the device 204 by utilizing routines provided within the kernel library file 224 to communicate with the driver 202, with a common device (camera) driver across different camera types. In some examples, the device 204 is configured to communicate in the kernel mode 220 using a format compliant with the specification defined by the driver 202.

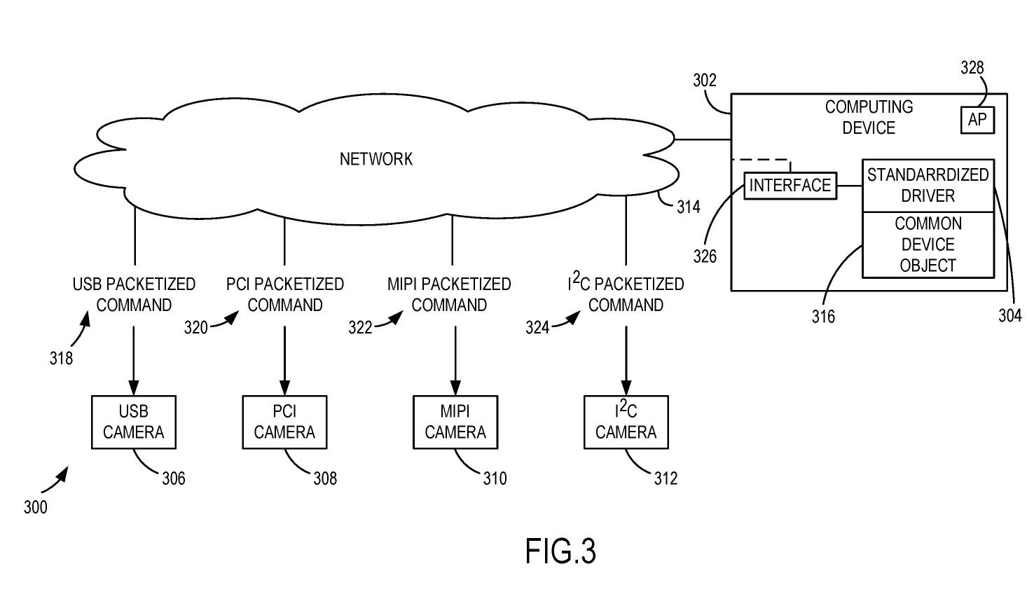

Thus, the present disclosure allows for management and configuration of the data stream from the device 204 to provide a discover capability for the operating system to discover one or more devices 204 having different camera types. For example, as illustrated in FIG. 3, a system 300 includes a computing device 302 having a standardized driver 304 configured according to the present disclosure. The standardized driver 304 allows plug and play functionality for any camera device connected to the computing device 302 and compliant with the standard implemented by the standardized driver 304. In the illustrated example, the computing device 302 is connected to a USB camera 306, a PCI camera 308 and a MIPI camera 310, through a network 314. It should be appreciated that one or more of the cameras 306, 308 and 310 can be connected directly to the computing device 302 and this configuration is contemplated by the present disclosure.

The computing device 302 is programmed with code that allows for the plug and play functionality through the standardized driver 304. The standardized driver 304 allows for an interface between the cameras 306, 308 and 310 with a common device object 316 (which may be implemented as the camera device object 212 illustrated in FIG. 2).

The common device object 316 is configured with command and control support for all of the different cameras 306, 308 and 310, such that the standardized driver 304 implements an interface 326 to the hardware of the cameras 306, 308 and 310, which in the illustrated example is a command and control interface, as well as a buffer interface. It should be appreciated that the bus type of the cameras 306, 308 and 310 is shown merely for example and the cameras are from different manufacturers in various examples. The present disclosure contemplates other bus types and cameras 306, 308 and 310 having several different manufacturers with the same bus type connected or different bus types through the network 314.

Each of the cameras 306, 308 and 310 has a uniqueness in communication requirements, such as based on the particular manufacturer and hardware implemented. These differences are abstracted by the standardized driver 304, such that the command, control and buffer structure are standardized for the different types of the cameras 306, 308 and 310. The standardized driver 304 generates a packetized command in way in which the cameras 306, 308 and 310 (that are compliant with the specification for the standardized driver 304) expect and can understand. In one example, data corresponding to the communication interface that defines the specification is published to independent hardware vendors or otherwise publicly available, as well as information regarding the device format running on the device 204 that is to be used in order to be compliant with the specification.

For example, a USB packetized command 318 is generated and sent to the camera 306, which queries the camera 306 for all the descriptors of the camera 306. The descriptors define all of the capabilities of the camera 306 (e.g., resolution, frame rate and media types supported by the camera 306). The descriptors generally define configuration data for the camera 306 that describes various functional capabilities of the camera 306. Similar packetized commands are generated and sent to the cameras 308 and 310 as a PCI packetized command 320 and a MIPI packetized command 322, respectively.

In some examples, the packetized commands 318, 320 and 322 are not initiated by the host, but by the camera 306, 308 or 310, in response to a command from the host (e.g. to declare its capabilities or to return frames), or as an interrupt to the host to notify the host of changes in the environment of the camera 306, 308 or 310 (e.g. availability of a frame data, occurrence of a thermal event, it detected presence of an object of interest or an activity of interest, etc.).

The standardized driver 304 defines a single way to interface with the kernel of the computing device 302 that manages the input/output (I/O) requested from software and translates the requests into data processing instructions for the processor of the computing device 302. Thus, different drivers are not downloaded each time a camera is connected to the network 314, but instead a single driver is used to generate the packetized commands that communicate with the cameras 306, 308 and 310 having different manufacturing types. As such, the standardized driver 304 provides camera type independent communication with the cameras 306, 308 and 310.

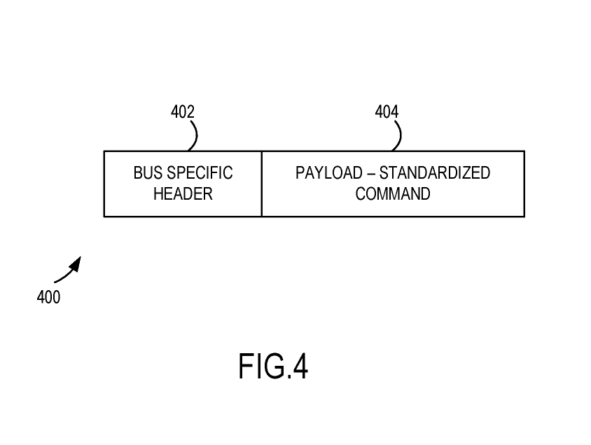

The packetized commands 318, 320 and 322 generated by the single standardized driver 304 simplifies the driver installation and device control process by abstracting the command and control structure for each of the different camera types into a single driver. For example, in some embodiments, the standardized driver 304 is configured in the kernel mode to provide a command and control structure with a data payload for each of the different camera types that is expected for that camera type (and as described in more detail in connection with FIG. 4).

The standardized driver 304 allows the cameras 306, 308 and 310 to communicate with the computing device 302 using suitable send/receive protocols, connections, and/or technologies that are abstracted for each of the camera types by the standardized driver 304. This plug and play functionality allows the computing device 302 to detect the connection of a new peripheral device, such as any one of the cameras 306, 308 and 310 and interact with the device using a single downloaded standardized driver 304, such as to connect to one of the cameras 306, 308 and 310. Thus, a single device driver is used and configured to allow the computing device 302 to interface with all of the cameras 306, 308 and 310 independent of the type of the cameras 306, 308 and 310. As should be appreciated, the standardized driver 304 can be updated as desired or needed (such as based on changes to one or more command or bus protocols for the camera) and provided in combination with an operating system update.

The standardized driver 304 in some examples is defined by a driver stack, which may be separately provided for each of the different bus types. For example, for a USB portion 226 (illustrated in FIG. 1), the standardized driver 304 includes in the driver stack a USB host controller driver that communicates to the USB device (e.g., the USB camera 306) and a low-level USB bus driver that communicates with the USB host controller and manages USB device power, enumeration, and various USB transactions. The driver stack in some examples also includes a USB packetized command driver that is customized for generating the USB packetized command 318 to allow for the standardized driver 304 to interface with the USB camera 306 (e.g., to generate a transmission specific protocol header and a standardized command payload). As should be appreciated, in other examples, the USB portion 226 may include a driver stack configured differently. Additionally, it should be appreciated that a different portion having a different driver stack may be provided for each of the different protocols, including for PCI and MIPI.

Thus, in some examples, the kernel mode 220 uses a core stack (such as a USB core stack) that may be a portion of the operating system, and that enables communication with the device 204 at the hardware level 228. The core stack may be part of or may be coupled to the driver 202 that manages the I/O of the device 204, more particularly, exposing the device 204 to the user mode 222.

Continuing with the USB example, one installed, the standardized driver 304 allows an application program (AP) 328 to communicate with the device driver. It should be appreciated that instead of creating a particular functional device object representative of USB devices, various examples create the common device object 316 that is a data object representative of any of the cameras 306, 308 and 310 (having different bus types), and exposes or provides an interface to the AP 328. Thus, the common device object 316 is device type independent and also supports multiple different bus type devices, such as the cameras 306, 308 and 310, each having a different manufacturer and bus type, and that is particularly recognized by the application program 328.

The packetized commands 318, 320 and 322 are configured in a packetization process as part of a data packet 400, for example as illustrated in FIG. 4, that includes a bus specific header portion 402 and a payload 404. As should be appreciated, and with continued reference to FIG. 4, for a particular command, while the header portion 402 is different for each of the cameras 306, 308 and 310 based on the bus protocol type (e.g., transmission protocol type), the payload 404 includes the same standardized command formatted based on the defined specification for the standardized driver 304. That is, the header portion 402 is configured based on the transmission protocol for each of the cameras 306, 308 and 310, while the command to perform a specific operation within the payload 404 is a standardized command that is the same for all of the cameras 306, 308 and 310. Thus, a single command corresponding to the common device object 316 can be transmitted to any of the cameras 306, 308 and 310 and results in the same operation being performed by each of the cameras 306, 308 and 310. In one example, the standardized commands can be formatted as follows:

StartStreaming(StreamID)

StopStreaming(StreamID)

QueryCamCapabilities (CameraDeviceID)

QueryPartialFrame(StreamID)

ConfigureStream(StreamID,Parameter)

Focus(StreamID,Parameter)—wherein the Parameter is ‘automatic’ or ‘manual’.

As should be appreciated, the present disclosure contemplates formatting any command in a standardized format. That is, any operation that the cameras 306, 308 and 310 can perform can be formatted as a standardized command and control structure by the standardized driver 304. For example, the standardized commands can include commands that query for the descriptors: device, configuration, interface and string; enumerate the device interfaces associated with a device interface class, and filter the interfaces by means of a vendor-supplied callback routine; selectively activate some interfaces of the device and leave others deactivated; generate control transfer requests; and/or transmit control, bulk, interrupt, and isochronous data. In one example, a set of APIs are provided and utilized in a particular operating system environment to provide routines using a standardized driver with a common device object as discussed herein. For example, the standardized command and control structure can support the actions discussed above and include any arguments for each command (command arguments) to control the specific functions or operations of the device.

Thus, in various examples, a kernel-mode common device driver is loaded in response a plug-in event of a new device, such as connection of one of the cameras 306, 308 and 310. It should be noted that in some examples, the initiation of the driver installation and connection with the cameras 306, 308 and 310 is performed based in part on a manual operation with user input selecting certain installation parameters.

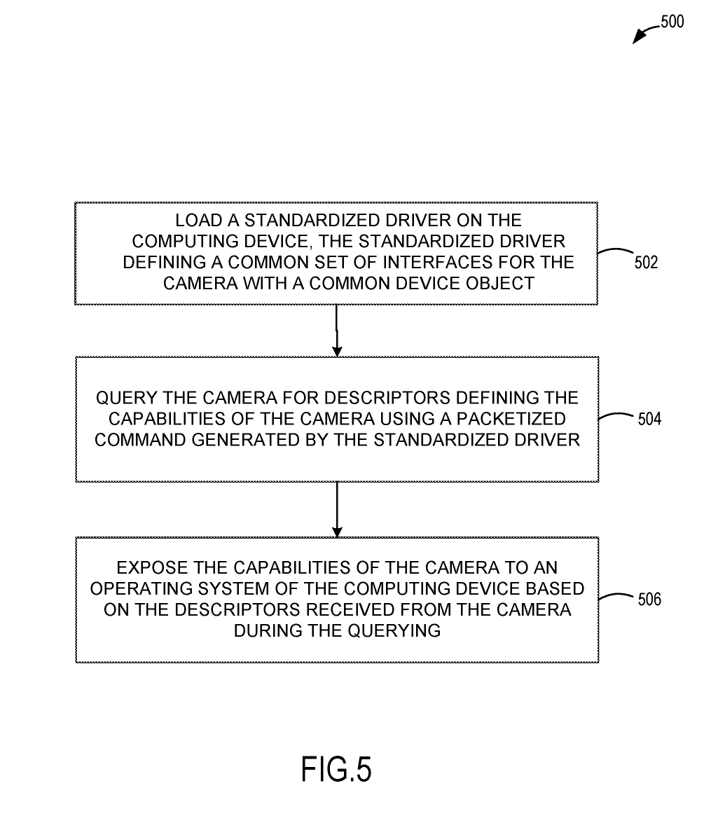

FIG. 5 is a flow chart 500 illustrating operation of a computing device (e.g., the computing device 302) configured to connect to a camera using a standardized driver according to one example. The operations illustrated in the flow charts described herein may be performed in a different order than are shown, may include additional or fewer steps and may be modified as desired or needed. Additionally, one or more operations may be performed simultaneously, concurrently or sequentially.

The camera device and control method includes, at 502, detecting a camera device connected to the system, such as the computing device. For example, a determination is made whether a new camera device is connected to a port of the system, such as when connecting a new USB camera device to the computing device for a first time.

A set of interfaces is then accessed at 504. The set of interfaces are defined by a standardized driver and are a common set of interfaces associated with a device object. The device object in various examples is compatible with camera devices from different camera device manufacturers.

In one example, a standardized driver is loaded on the computing device, such as from storage within the computing device. For example, an installation location within the computing device contains different files that are used during installation processes on the computing device (e.g., installation of a newly connected peripheral device). As described herein, the standardized driver defines a common set of interfaces for the camera with a common device object. Thus, each time a new camera is connected to the computing device, a different driver is not loaded depending on the type of camera being installed (e.g., based on the manufacturer of the camera). Instead, the standardized driver is configured with command and control structures to generate a packetized command that includes a data payload that the installed camera expects, such as in the standardized command format for the standard driver.

The command and control structure generates the packetized commands based on the specification standard, with which the device is also compliant. For example, the command and control structure allows for querying the detected camera at 506 (based at least one the accessed set of interfaces) for descriptors defining the capabilities of the camera using a packetized command generated by the standardized driver (e.g., a data packet having a transmission protocol header specific to a bus type and a payload with a standardized command).

The camera, which is compliant with the standard for the standardized driver, receives in the payload of the packetized command the query command as expected and responds with the capabilities of the camera. That is, the command is configured in a format that allows the driver to communicate with the camera regardless of the manufacturer of the camera, as well as the bus type of the camera.

For example, the standardized driver operates within a format that is compliant with the specification that can command the same operation to be performed on cameras of different types. In one example, cameras of different types are defined as cameras from different manufacturers, which may have the same or different types of communication buses. In another example, cameras of different types are defined as cameras having different hardware components that have different control interfaces, but that can be from the same manufacturer. As such, communications between the camera and the computing device have a format (abstracted for the differences in the control requirements for the different camera types) that allows for interfacing regardless of the camera type.

At 508, based on the descriptors, one or more interfaces of the accessed set of interfaces is provided to one or more applications to make the camera device available to the one or more applications. For example, the capabilities of the camera are made available to the one or more applications executing on the computing device based on the descriptors received from the camera during the querying. Camera device command and control can then be provided.

In the illustrated example, a command is received from the one or more applications via the provided interfaces at 510. The camera device is then controlled based on the received command. For example, as described herein, packetized commands are generated to command the camera device. In some examples, the command is received from the camera device as described herein.

Thus, using the standardized driver, the capabilities of different types of cameras connected to the computing device can be identified and accessed using a single driver without specialized commands for the different cameras. A set of interfaces are thereby provided to communicate with differently configured cameras, such that the computing device is compatible with cameras from different manufacturers using a single standardized driver. With the present disclosure, different drivers that format special commands for different device manufacturers are not used, but instead a standardized set of interfaces defined by standard command and control structures allow a single driver to be provided for communicating with the different camera types.

Specifically, the present disclosure defines a common device object that works with all camera types, rather than using separate drivers for each device. In one example, the commands can be provided as part of an API. Additionally, the command and control structure is defined within a specification that allows for a standard way to interface with any camera (instead of a specialized interface for each of the different cameras), including cameras from different manufacturers. The specification defines a standard that allows for cameras that are compliant with the standard to be controlled using the standardized driver, such as having a single command to perform the same operation on different cameras using the standardized driver. In one example, the specification is defined based on the specific requirements for control operations for each of the different camera types using commands that the particular camera expects to receive (when compliant with the standardized driver format). The commands are generated as packetized commands with data payloads that the device is able to receive and process regardless of the camera type. In one particular example, the specific communication protocol requirements for each of the different bus types are packetized with the standardized command payload that abstracts the differences between control commands for the different types of cameras. Thus, the standardized driver generates packetized commands that, based on the specification, can be used to control the compliant devices to perform or respond as is expected for the particular camera type.

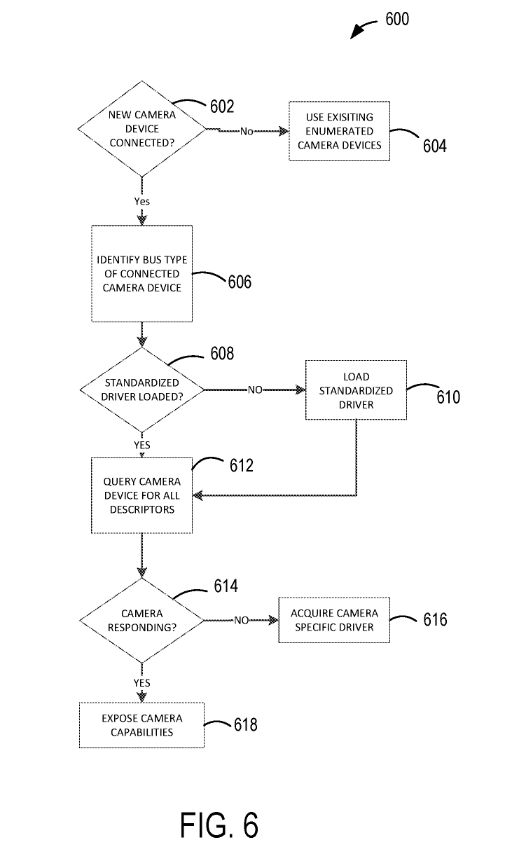

An operational example is shown in the flow chart 600 illustrated in FIG. 6. It should be appreciated that the present disclosure contemplates use with any type of operating system and any type of device, including different types of cameras, that are configured according to standardized command and control structures as described herein. A computing device configured according to FIG. 6 is able to have installed a single driver that allows the operating system to interact with connected devices, such as connected cameras, of the same or different types (e.g., cameras from different manufacturers).

At 602, a determination is made whether a new camera device is connected to the system. For example, a determination is made whether a new camera device is connected to a port of the system, such as when connecting a new USB camera device to the computing device for a first time. This determination is made, for example, upon the detection of the connection of any peripheral device to the computing device. If the new newly connected deice is not a camera device (e.g., a printer or keyboard device), an existing set of enumerated camera devices are used. For example, one or more applications use a standard way of enumerating the presently available devices and the capabilities of the devices, which were previously connected, such as using a common device object and standardized driver as described herein. If no cameras are connected to the computing device, the one or more application do not have any device to enumerate and none are available for access by a user.

If a new camera device is connected at 602, for example, if a USB camera device is detected using port detection technology, then the computing device in some examples identifies at 606 a bus type of a camera connected to the computing device. For example, when a new camera is coupled to the system, such as a “plug and play” camera having a particular bus type and that has not previously been connected to the computing device, the computing device uses interface or bus detection methods to identify that the connected device is a particular type of camera, as well as the bus type of the camera. In a USB camera example, the computing device recognizes a USB key of the USB camera upon connection of the USB camera to a port of the computing device, which may include a camera device ID that indicates that manufacturer of the camera device.

A determination is then made at 608 whether a standardized driver has been loaded. For example, the standardized driver could have been previously loaded if available and another camera device was previously connected to the computing device. If the standardized driver is not loaded, then at 610 the standardized driver is loaded. As described herein, the standardized driver defines a common device object for cameras of different types using standardized command and control structures. The common device object has support for and is compatible with any compliant camera, such that specialized commands and procedures (e.g., device type specific commands) are not needed. Instead, in some examples, a set of APIs is provided that allows for exposing the camera to the computing device and allowing communication with the camera device regardless of the camera type, including the manufacturer of the camera device or the bus type of the device. For example, a set of interfaces defined by a single standardized driver are provided to communicate with different camera types. Thus, a simplified plug and play functionality is thereby provided having a single common device object.

If a determination is made at 608 that the standardized driver is already loaded or if the standardized driver is loaded at 610, the device is queried for all of the descriptors for the camera at 612. For example, the loaded driver expects certain descriptors on the device to control the device and allow the device functionalities to be enumerated to one or more applications. Accordingly, at 612, a packetized command (having a bus specific header) is sent to the connected device in an attempt to acquire the descriptors (e.g., descriptors defining all of the capabilities of the device—resolution, frame rate, media types supported, etc.) of the camera device.

A determination is then made at 614 whether the camera device responds to the packetized command. For example, a determination is made whether the camera device responds with the expected descriptors defining the capabilities of the camera device. If no response is received, such as within a predefined time period, a determination is made that the camera device is a non-compliant camera (e.g., not configured according to the standardized device driver format) and a camera specific driver is acquired at 616. For example, using driver acquisition and installation processes in the device driver technology, a search is performed locally and/or remotely (e.g., at the website of the manufacturer of the camera device) to identify, acquire and install the device specific driver on the computing device to allow for communication with the non-compliant camera. This process may be performed using any suitable device driver process, such as defined by the manufacturer of the camera.

If a determination is made that the camera device responds at 614, then at 618, the capabilities of the camera device are exposed to the operating system of the computing device. For example, based on the descriptors for the camera device, the common device object is able to identify and provide the capabilities of the camera device to the operating system in a format that can be used by the operating system, and as described herein. Thereafter, one or more applications installed on the computing device can enumerate the camera device (and any other connected camera devices), including the capabilities of the camera device to allow user selection of a particular camera device and operation. For example, if two camera devices are available having video graphics array (VGA) and 1080p streaming capabilities, respectively, and a user desires to stream high-definition video (e.g., based on a user input), an API call (start streaming) is made to the 1080p camera device to start streaming video. Thus, the present disclosure allows for managing the operation of different camera devices, such as camera streams (starting, stopping, configuring the streams), auto/manual focus types of parameters, etc.

As should be appreciated, and for example, the start streaming command is followed by a stop streaming command (defined in specification) and received in a way expected by the camera device (i.e., a packetized command in a way that the device will understand). As should also be appreciated, the communication with the camera is made possible using the standardized driver of the present disclosure that abstracts the differences between the different camera types (e.g., command, control and buffer structure are standardized). As should further be appreciated, each type of camera device has different sets of functionality, but can have some overlap in commands. The present disclosure can account for these different and overlaps across the different types of camera devices to discover the instrumentality available in the hardware using an intuitive query interface to understand the camera device itself. Additionally, the present disclosure can be used in connection with non-camera devices, such as with other peripheral devices configured with standardized command and control structures for that class or type of devices.

Thus, with the standardized driver, for any operating system that includes the command and control structures code, plug and play functionality can be provided with any camera device compliant with the standard. That is, a single way is provided for interfacing with the kernel mode of the operating system. Additionally, any driver updates can be performed with the operating system update and can be provided as a single update and not multiple updates for each different camera type.

### Exemplary Operating Environment

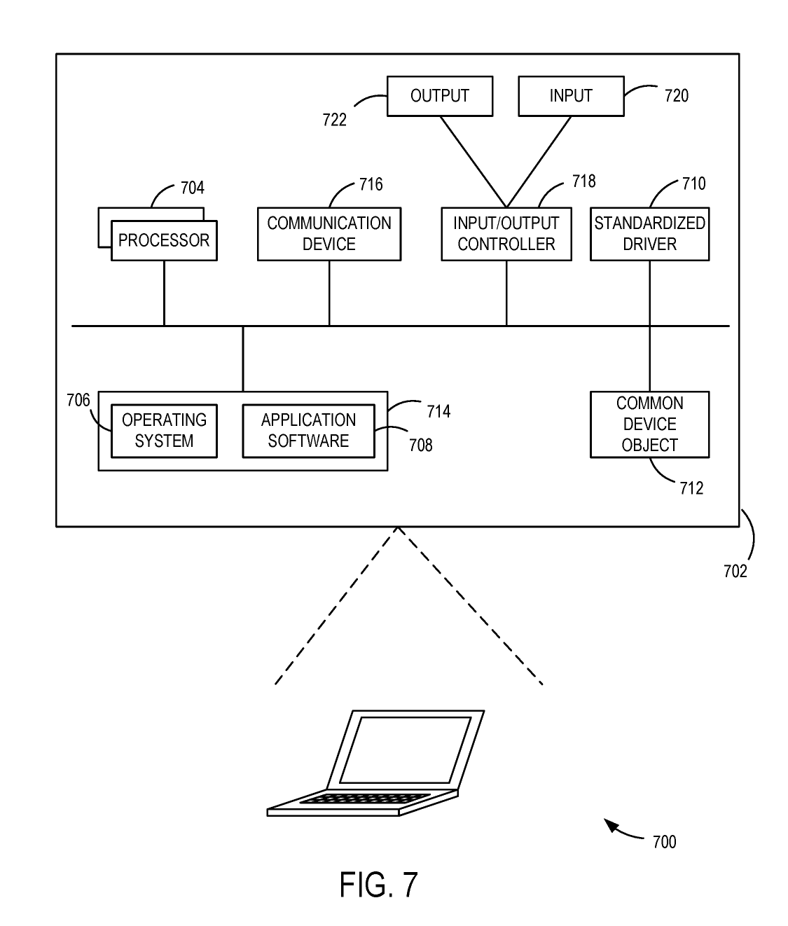

The present disclosure is operable with a computing apparatus 702 according to an embodiment as a functional block diagram 700 in FIG. 7 that is capable of connection, for example, to different types of camera devices. In an embodiment, components of the computing apparatus 702 may be implemented as a part of an electronic device according to one or more embodiments described in this specification. The computing apparatus 702 comprises one or more processors 704 which may be microprocessors, controllers or any other suitable type of processors for processing computer executable instructions to control the operation of the electronic device. Platform software comprising an operating system 706 or any other suitable platform software may be provided on the apparatus 702 to enable application software 708 to be executed on the device. According to an embodiment, communication with a connected device (e.g., USB camera) using a standardized driver 710 with a common device object 712 may be accomplished by software.

Computer executable instructions may be provided using any computer-readable media that are accessible by the computing apparatus 702. Computer-readable media may include, for example, computer storage media such as a memory 714 and communications media. Computer storage media, such as the memory 714, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 714) is shown within the computing apparatus 702, it will be appreciated by a person skilled in the art, that the storage may be distributed or located remotely and accessed via a network or other communication link (e.g. using a communication device 716).

The computing apparatus 702 may comprise an input/output controller 718 configured to output information to one or more input devices 720 and output devices 722, for example a display, a speaker or a camera, which may be separate from or integral to the electronic device. The input/output controller 718 may also be configured to receive and process an input from one or more input devices 720, for example, a keyboard, a microphone or a touchpad. In one embodiment, the output device 722 may also act as the input device 720. An example of such a device may be a touch sensitive display. The input/output controller 718 may also output data to devices other than the output device 722, e.g. a locally connected printing device or camera device. In some embodiments, a user may provide input to the input device(s) 720 and/or receive output from the output device(s) 722.

In some examples, the computing apparatus 702 detects voice input, user gestures or other user actions and provides a natural user interface (NUI). This user input may be used to author electronic ink, view content, select ink controls, play videos with electronic ink overlays and for other purposes. The input/output controller 718 outputs data to devices other than a display device in some examples, e.g. a locally connected printing device or camera device.

The functionality described herein can be performed, at least in part, by one or more hardware logic components. According to an embodiment, the computing apparatus 702 is configured by the program code when executed by the processor(s) 704 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, etc.) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that may be suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices may accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions or the specific components or modules illustrated in the figures and described herein. Other examples of the disclosure may include different computer-executable instructions or components having more or less functionality than illustrated and described herein.

In examples involving a general-purpose computer, aspects of the disclosure transform the general-purpose computer into a special-purpose computing device when configured to execute the instructions described herein.

Alternatively, or in addition to the other examples described herein, examples include any combination of the following:

A system for camera device command and control, the system comprising:

at least one processor; and

at least one memory comprising computer program code, the at least one memory and the computer program code configured to, with the at least one processor, cause the at least one processor to:

detect a camera device connected to the system;

access a set of interfaces defined by a standardized driver, the set of interfaces being a common set of interfaces associated with a device object, the device object being compatible with camera devices from different camera device manufacturers;

query the detected camera device for descriptors defining capabilities of the camera device using a packetized command generated based at least on the accessed set of interfaces;

provide, based on the descriptors, one or more interfaces of the accessed set of interfaces to one or more applications to make the camera device available to the one or more applications;

receive a command from the one or more applications via the provided one or more interfaces; and

control the camera device based on the received command.

The system described above, wherein the camera devices having the different camera device manufactures have different communication protocols and the computer program code is further configured to, with the at least one processor, cause the at least one processor to communicate with the camera device using data packets having a transmission protocol header defined based on a bus type of the camera device, including processing a packetized command received from the camera device, the packetized command including the data packets having the transmission protocol header defined based on the bus type of the camera device.

The system described above, wherein the computer program code is further configured to, with the at least one processor, cause the at least one processor to provide a set of application programming interfaces (APIs) as the set of interfaces to communicate with the camera device using a standardized command and control interface format defined by the standardized driver.

The system described above, wherein the computer program code is further configured to, with the at least one processor, cause the at least one processor to generate the packetized command to query the camera device with a data packet having (i) a transmission protocol specific header based on a bus communication protocol of the camera device and (ii) a data payload with one or more standardized commands.

The system described above, wherein the computer program code is further configured to, with the at least one processor, cause the at least one processor to update the standardized driver with an update for the operating system.

The system described above, wherein the standardized driver is configured to abstract differences in control commands for the camera devices having different manufacturers, at least some of the camera devices having different operating configurations and command control requirements.

The system described above wherein the computer program code is further configured to, with the at least one processor, cause the at least one processor to provide a specification for standardized commands defining the standardized driver, the specification defining a plurality of command arguments for controlling the camera device.

A computerized method for camera device command and control, the computerized method comprising:

detecting a camera device connected to the system;

accessing a set of interfaces defined by a standardized driver, the set of interfaces being a common set of interfaces associated with a device object;

querying the detected camera device for descriptors defining capabilities of the camera device using a packetized command generated based at least on the accessed set of interfaces;

providing, based on the descriptors, one or more interfaces of the accessed set of interfaces to one or more applications to make the camera device available to the one or more applications;

receiving a command from the one or more applications via the provided one or more interfaces; and

controlling the camera device based on the received command.

The computerized method described above, wherein the device object is compatible with camera devices from different camera device manufacturers, the camera devices having the different camera device manufactures have different communication protocols and further comprising communicating with the camera device using data packets having a transmission protocol header defined based on a bus type of the camera device, including processing a packetized command received from the camera device, the packetized command including the data packets having the transmission protocol header defined based on the bus type of the camera device.

The computerized method described above, further comprising providing a set of application programming interfaces (APIs) as the set of interfaces to communicate with the camera device using a standardized command and control interface format defined by the standardized driver.

The computerized method described above, further comprising generating the packetized command to query the camera device with a data packet having (i) a transmission protocol specific header based on a bus communication protocol of the camera device and (ii) a data payload with one or more standardized commands.

The computerized method described above, further comprising updating the standardized driver with an update for the operating system.

The computerized method described above, wherein the standardized driver is configured to abstract differences in control commands for the camera devices having different manufacturers, at least some of the camera devices having different operating configurations and command control requirements.

The computerized method described above, further comprising providing a specification for standardized commands defining the standardized driver, the specification defining a plurality of command arguments for controlling the camera device.

One or more computer storage media having computer-executable instructions for camera device command and control, upon execution by a processor, cause the processor to at least:

detect a camera device connected to the system;

access a set of interfaces defined by a standardized driver, the set of interfaces being a common set of interfaces associated with a device object;

query the detected camera device for descriptors defining capabilities of the camera device using a packetized command generated based at least on the accessed set of interfaces;

provide, based on the descriptors, one or more interfaces of the accessed set of interfaces to one or more applications to make the camera device available to the one or more applications;

receive a command from the one or more applications via the provided one or more interfaces; and

control the camera device based on the received command.

The one or more computer storage media described above, wherein the device object is compatible with camera devices from different camera device manufacturers, the camera devices having the different camera device manufactures have different communication protocols and having further computer-executable instructions that, upon execution by a processor, cause the processor to at least communicate with the camera device using data packets having a transmission protocol header defined based on a bus type of the camera device, including processing a packetized command received from the camera device, the packetized command including the data packets having the transmission protocol header defined based on the bus type of the camera device.

The one or more computer storage media described above having further computer-executable instructions that, upon execution by a processor, cause the processor to at least provide a set of application programming interfaces (APIs) as the set of interfaces to communicate with the camera device using a standardized command and control interface format defined by the standardized driver.

The one or more computer storage media described above having further computer-executable instructions that, upon execution by a processor, cause the processor to at least generate the packetized command to query the camera device with a data packet having (i) a transmission protocol specific header based on a bus communication protocol of the camera device and (ii) a data payload with one or more standardized commands.

The one or more computer storage media described above having further computer-executable instructions that, upon execution by a processor, cause the processor to at least update the standardized driver with an update for the operating system.

The one or more computer storage media described above, wherein the standardized driver is configured to abstract differences in control commands for the camera devices having different manufacturers, at least some of the camera devices having different operating configurations and command control requirements, and having further computer-executable instructions that, upon execution by a processor, cause the processor to at least provide a specification for standardized commands defining the standardized driver, the specification defining a plurality of command arguments for controlling the camera device.

Any range or device value given herein may be extended or altered without losing the effect sought, as will be apparent to the skilled person.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute exemplary means for camera driver installation and camera control. The illustrated one or more processors 704 together with the computer program code stored in memory 714 constitute exemplary processing means for connecting to a camera device, including camera driver installation and camera control.

The term “comprising” is used in this specification to mean including the feature(s) or act(s) followed thereafter, without excluding the presence of one or more additional features or acts.

In some examples, the operations illustrated in the figures may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

The order of execution or performance of the operations in examples of the disclosure illustrated and described herein is not essential, unless otherwise specified.

That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system for camera device command and control, the system comprising:
at least one processor; and
at least one memory comprising computer program code, the at least one memory and the computer program code configured to, with the at least one processor, cause the at least one processor to:
detect a camera device connected to the system;
access a set of interfaces defined by a standardized driver, the set of interfaces being a common set of interfaces associated with a device object, the device object being compatible with camera devices from different camera device manufacturers;
query the detected camera device for descriptors defining capabilities of the camera device using a packetized command generated based at least on the accessed set of interfaces;
provide, based on the descriptors, one or more interfaces of the accessed set of interfaces to one or more applications to make the camera device available to the one or more applications;
receive a command from the one or more applications via the provided one or more interfaces; and
control the camera device based on the received command.

2. The system of claim 1, wherein the camera devices having the different camera device manufactures have different communication protocols and the computer program code is further configured to, with the at least one processor, cause the at least one processor to communicate with the camera device using data packets having a transmission protocol header defined based on a bus type of the camera device, including processing a packetized command received from the camera device, the packetized command including the data packets having the transmission protocol header defined based on the bus type of the camera device.

3. The system of claim 1, wherein the computer program code is further configured to, with the at least one processor, cause the at least one processor to provide a set of application programming interfaces (APIs) as the set of interfaces to communicate with the camera device using a standardized command and control interface format defined by the standardized driver.

4. The system of claim 1, wherein the computer program code is further configured to, with the at least one processor, cause the at least one processor to generate the packetized command to query the camera device with a data packet having (i) a transmission protocol specific header based on a bus communication protocol of the camera device and (ii) a data payload with one or more standardized commands.

5. The system of claim 1, wherein the computer program code is further configured to, with the at least one processor, cause the at least one processor to update the standardized driver with an update for the operating system.

6. The system of claim 1, wherein the standardized driver is configured to abstract differences in control commands for the camera devices having different manufacturers, at least some of the camera devices having different operating configurations and command control requirements.

7. The system of claim 1, wherein the computer program code is further configured to, with the at least one processor, cause the at least one processor to provide a specification for standardized commands defining the standardized driver, the specification defining a plurality of command arguments for controlling the camera device.

8. A computerized method for camera device command and control, the computerized method comprising:
detecting a camera device connected to the system;
accessing a set of interfaces defined by a standardized driver, the set of interfaces being a common set of interfaces associated with a device object;
querying the detected camera device for descriptors defining capabilities of the camera device using a packetized command generated based at least on the accessed set of interfaces;
providing, based on the descriptors, one or more interfaces of the accessed set of interfaces to one or more applications to make the camera device available to the one or more applications;
receiving a command from the one or more applications via the provided one or more interfaces; and
controlling the camera device based on the received command.

9. The computerized method of claim 8, wherein the device object is compatible with camera devices from different camera device manufacturers, the camera devices having the different camera device manufactures have different communication protocols and further comprising communicating with the camera device using data packets having a transmission protocol header defined based on a bus type of the camera device, including processing a packetized command received from the camera device, the packetized command including the data packets having the transmission protocol header defined based on the bus type of the camera device.

10. The computerized method of claim 8, further comprising providing a set of application programming interfaces (APIs) as the set of interfaces to communicate with the camera device using a standardized command and control interface format defined by the standardized driver.

11. The computerized method of claim 8, further comprising generating the packetized command to query the camera device with a data packet having (i) a transmission protocol specific header based on a bus communication protocol of the camera device and (ii) a data payload with one or more standardized commands.

12. The computerized method of claim 8, further comprising updating the standardized driver with an update for the operating system.

13. The computerized method of claim 8, wherein the standardized driver is configured to abstract differences in control commands for the camera devices having different manufacturers, at least some of the camera devices having different operating configurations and command control requirements.

14. The computerized method of claim 8, further comprising providing a specification for standardized commands defining the standardized driver, the specification defining a plurality of command arguments for controlling the camera device.

15. One or more computer storage media having computer-executable instructions for camera device command and control, upon execution by a processor, cause the processor to at least:
detect a camera device connected to the system;
access a set of interfaces defined by a standardized driver, the set of interfaces being a common set of interfaces associated with a device object;
query the detected camera device for descriptors defining capabilities of the camera device using a packetized command generated based at least on the accessed set of interfaces;
provide, based on the descriptors, one or more interfaces of the accessed set of interfaces to one or more applications to make the camera device available to the one or more applications;
receive a command from the one or more applications via the provided one or more interfaces; and
control the camera device based on the received command.

16. The one or more computer storage media of claim 15, wherein the device object is compatible with camera devices from different camera device manufacturers, the camera devices having the different camera device manufactures have different communication protocols and having further computer-executable instructions that, upon execution by a processor, cause the processor to at least communicate with the camera device using data packets having a transmission protocol header defined based on a bus type of the camera device, including processing a packetized command received from the camera device, the packetized command including the data packets having the transmission protocol header defined based on the bus type of the camera device.

17. The one or more computer storage media of claim 15 having further computer-executable instructions that, upon execution by a processor, cause the processor to at least provide a set of application programming interfaces (APIs) as the set of interfaces to communicate with the camera device using a standardized command and control interface format defined by the standardized driver.

18. The one or more computer storage media of claim 15 having further computer-executable instructions that, upon execution by a processor, cause the processor to at least generate the packetized command to query the camera device with a data packet having (i) a transmission protocol specific header based on a bus communication protocol of the camera device and (ii) a data payload with one or more standardized commands.

19. The one or more computer storage media of claim 15 having further computer-executable instructions that, upon execution by a processor, cause the processor to at least update the standardized driver with an update for the operating system.

20. The one or more computer storage media of claim 15, wherein the standardized driver is configured to abstract differences in control commands for the camera devices having different manufacturers, at least some of the camera devices having different operating configurations and command control requirements, and having further computer-executable instructions that, upon execution by a processor, cause the processor to at least provide a specification for standardized commands defining the standardized driver, the specification defining a plurality of command arguments for controlling the camera device.
